(19) United States
(12) Patent Application Publication
(10) Pub. No.: US 2015/0010682 A1
(43) Pub. Date: Jan. 8, 2015

(54) KITCHEN UTENSIL

(71) Applicant: Laleh Vazin Sotoohi, Irvine, CA (US)

(72) Inventor: Laleh Vazin Sotoohi, Irvine, CA (US)

(21) Appl. No.: 13/936,370

(22) Filed: Jul. 8, 2013

(51) Int. Cl. A47J 19/02; A47J 43/25

(52) U.S. Cl. CPC A47J 19/025; A47J 43/25
USPC 426/489; 241/84.2; 99/510

(57) ABSTRACT

A combination grating and juicing apparatus comprising a bowl-shaped combination grater and juicer, a receptacle for containing grated and juiced food products, and a pressure applicator. The concave surface is a grater with a plurality of cutting edges, and the convex surface is a juicer with a plurality of ridges. The combination grater and juicer fits onto the receptacle in two positions: a grating position in which the grating surface is accessible, and a juicing position in which the juicing surface is accessible. Apertures in the combination grater and juicer allow for grated and juiced food products to pass through the grater and juicer and into the receptacle. The pressure application is used for grating, and fits onto the combination juicer and grater, where it may be rotated to apply pressure to food products so as to grate them against the cutting edges of the grating surface.

### CROSS-REFERENCE TO RELATED APPLICATIONS

Not applicable

### STATEMENT RE: FEDERALLY SPONSORED RESEARCH/DEVELOPMENT

Not applicable

### BACKGROUND

1. Technical Field

The present disclosure relates generally to implements for use in the kitchen. More particularly, the present disclosure relates to graters and juicers, and combinations thereof.

2. Related Art

A large variety of kitchen implements have been invented to grate, shred, or chop material into smaller particles. Such implements include graters, knives, presses, sieves, food mills, ricers, zesters, blenders, and food processors. Likewise, a large variety of kitchen implements may be used to liquefy or juice material. Such implements include juicers, reamers, crushers, squeezers, and blenders. Unfortunately, these implements suffer from various deficiencies.

Consequently, there is a need for an improved apparatus and method for juicing and grating.

### BRIEF SUMMARY

To solve this and other problems, a combination grating and juicing apparatus is contemplated wherein the user may transition from grating to juicing, and vice-versa, by flipping over a bowl-shaped grating and juicing member.

The bowl-shaped grating and juicing member is part of the combination grating and juicing apparatus and defines an opposing concave grating surface and convex juicing surface. This bowl-shaped member may have a plurality of apertures for allowing juice or grated food product to pass therethrough. The curvature of the concave and convex surfaces of the member may be bulbous, egg shaped, spherical, or other shape that is symmetrical about a vertical axis of the member. By way of example and not limitation, the curvature may be radially symmetrical about a vertical axis. More particularly, the curvature may be such that an intersection between a transverse plane perpendicular to a vertical axis and the concave and convex surfaces may have a distance equidistant to the vertical axis. The concave surface may be configured with a plurality of cutting edges to grate a first food product. The convex surface may be configured with a plurality of ridges to juice a second food product. The plurality of apertures may be sized and configured to allow a grated first food product to pass through the apertures when the bowl-shaped member is traversed to a grating position and first food product traversed against the concave surface. The plurality of apertures may also allow juice from a second food product to pass through the apertures when the bowl-shaped member is traversed to a juicing position and the second food product is pushed against and rubbed against the convex surface.

The apparatus may further comprise a pressure applicator for bringing the first food product into contact with the concave grating surface. In such an embodiment, the grating and juicing member may have an annular rim and an annular flange. The pressure applicator may have an annular ridge sized and positioned to be seated on the annular rim and within the annular flange. The pressure applicator may also have a bulbous protrusion which protrudes into close proximity with the concave surface of the grating and juicing member when seated as such, but without the bulbous protrusion contacting the concave grating surface. The bulbous protrusion may have a first surface portion and a second surface portion. The first surface portion may be closely juxtaposed to the concave surface of the grating and juicing member. More particularly, the first surface portion may be gapped away from the concave surface a constant distance. By way of example and not limitation, a distance from any two points on the first surface portion intersecting with any one plane transverse to the vertical axis of the grating and juicing member may be each to each other. In such an embodiment, at least two points on the second surface portion intersecting with at least one plane transverse to the vertical axis may not be at a constant radial distance from the vertical axis. By way of example and not limitation, the second surface portion may progressively be gapped away from the concave grating surface. The second surface portion and the concave grating surface may define a second gap distance which is greater than a first gap distance between the first surface portion and the concave grating surface. The second gap distance may be may be sized and dimensioned to receive a first food product (e.g., garlic clove, chopped food product, etc.). When the first food product is disposed between the second surface portion and the concave grating surface, the pressure applicator may then be rotated to press the first food product against the plurality of cutting edges of the concave grating surface to grate the first food product. The bulbous protrusion may be dimensioned to be, for example, spherical, hemispherical, concical, prolate spheroid, ellipsoid, or combinations thereof. The distance between the first surface portion and the concave grating surface may be between 1/32 and ⅛ of an inch. The distance between the second surface portion and the concave grating surface may increase until a maximum gap distance is reached, then such distance may start to decrease. The second surface portion may blend to the first surface portion. The curvature of the second surface taken upon a plane transverse to the vertical axis of the pressure applicator may, by way of example and not limitation, be described as stepwise, linear, sinusoidal, exponential, logarithmic, curvilinear, or combinations thereof. It is also contemplated that grating or zesting may be performed without using the pressure applicator by manually pressing a first food product against the grating surface. By way of example and not limitation, a user may press the exterior surface of a lemon, lime or other food product to remove the top layer of the food product's rind.

Other embodiments may comprise a receptacle for containing a grated first food product and a juiced second food product. The grating and juicing member may be attached to the receptacle when used in a grating position and/or a juicing position. The attachment in the grating position may be achieved by a first set of threads on the grating and juicing member and a second set of threads on the receptacle, wherein said first and second set of threads are threadedly engageable. The attachment in the juicing position may be achieved by an annular rim and an annular flange on the grating and juicing member and an annular lip on the receptacle, wherein the annular rim seats upon the annular lip and the annular flange fits around the annular lip. The annular threads on the grating and juicing member may be juxtaposed (e.g., attached, disposed adjacent to, laid on top of) with an annular wall. The annular wall may be sufficiently high to contain a juiced second food product when the grating and juicing member is used to juice a second food product. Although threads have been shown and described, other means for attaching are also contemplated, such as friction fit, snap on, or other means which are known or developed in the future.

A further embodiment is contemplated which comprises the grating surface and the pressure applicator.

Additionally, a method of using the combination grating and juicing apparatus is likewise contemplated in which an embodiment of the grating and juicing member is provided, and the user may flip over the member to the grating position to access the grating surface, and may flip over the member to the juicing position to access the juicing surface, for quick and convenient juicing and grating.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a side view of a pressure applicator, a combination grating and juicing member, and a receptacle;

FIG. 2 is a side view of the pressure applicator taken upon line 2 of FIG. 1;

FIG. 3 is a side view of the pressure applicator taken upon line 3 of FIG. 1, showing a configuration of a second surface portion of the bulbous protrusion of the pressure applicator;

FIG. 4 is a top view of a pressure applicator taken upon line 4 of FIG. 1;

FIG. 5 is a side view of a grating and juicing member and a receptacle wherein the grating and juicing member is in a juicing position;

FIG. 6 is a top view of a grating and juicing member taken upon line 6 of FIG. 5 showing a convex juicing surface having a plurality of ridges and a plurality of apertures; and

FIG. 7 is a view taken upon line 7 of FIG. 1 of a planar segment of a bulbous protrusion of a pressure applicator seated in a grating and juicing member.

### DETAILED DESCRIPTION

A combination grating and juicing apparatus 10 is contemplated which has a bowl-shaped grating and juicing member 12 having opposing concave grating surface 14 and a convex juicing surface 16 which can be flipped over to easily access either the grating surface 14 or the juicing surface 16 when cooking and plurality of apertures 18 for allowing grated food product or juice to flow therethrough into a receptacle 22. The concave grating surface 14 may have a plurality of cutting edges. The convex juicing surface 16 may have a plurality of ridges. The user may transition from one function to the other by flipping over the grating and juicing member 12 to access the opposing surface. In this way, the grating and juicing member 12 is reversible to provide for easy and quick access to either surface 14, 16. Further, a pressure applicator 20 may be used when the grating and juicing member 12 is flipped over to the grating position to apply pressure to a first food product against the cutting edges of the grating surface 14.

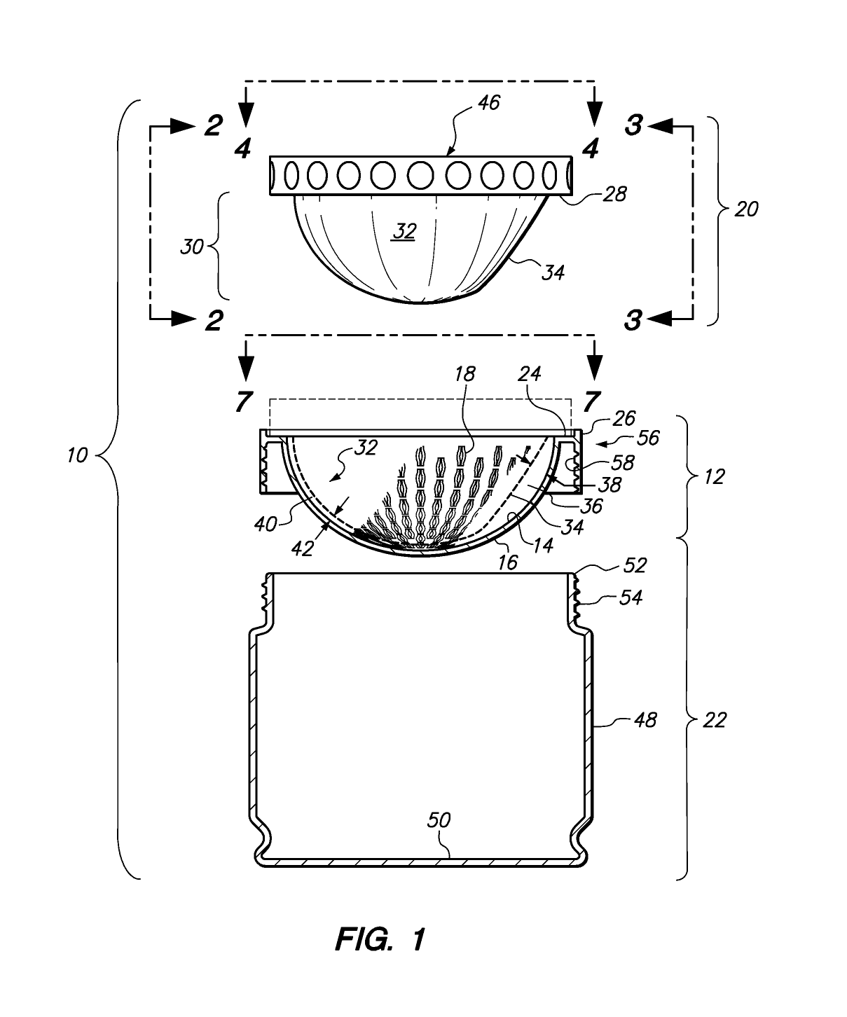

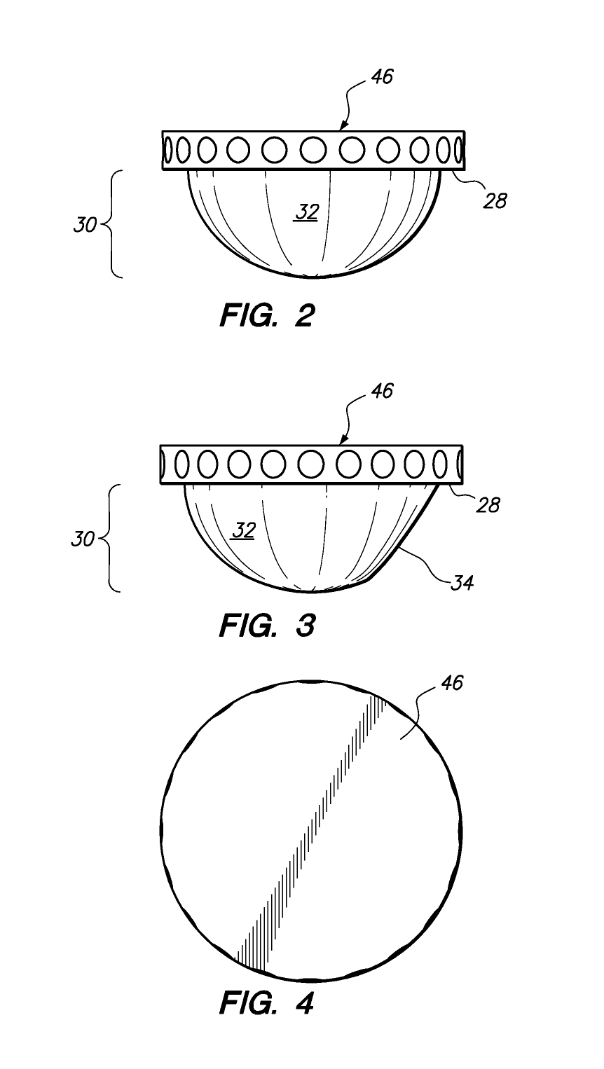

Referring now to the drawings, and more specifically to FIG. 1, a combination grater and juicer assembly 10 is shown which comprises a grating and juicing member 12, a pressure applicator 20, and a receptacle 22. The grating and juicing member 12 may be bowl-shaped with an opposing concave grating surface 14 and a convex juicing surface 16, a plurality of apertures 18, an annular rim 24, and an annular flange 26. The concave grating surface 14 and the convex juicing surface 16 may form opposing surfaces of the bowl-shaped grating and juicing member 12. The grating and juicing member 12 may be made of any material that is suitable for use in kitchen implements, including but not limited to metal (e.g., stainless steel), plastic, ceramic, or combinations thereof. The concave grating surface 14 may be radially symmetrically about a vertical axis such that all points on the concave grating surface 14 intersecting with a plane transverse to the vertical axis are at a constant radius to the vertical axis. The concave grating surface 14 of the grating and juicing member 12 may be configured with a plurality of cutting edges to grate a first food product pressed against the plurality of cutting edges of concave grating surface 14. The plurality of cutting edges of the concave grating surface 14 may be any type of cutting edges that are suitable for grating or zesting, including but not limited to teeth or blades. The convex juicing surface 16 of the grating and juicing member 12 may be configured with a plurality of ridges to juice a second food product pressed against the convex juicing surface 16. The grated first food product or the juiced second food product may pass through one or more of the plurality of apertures 18 after being grated or juiced.

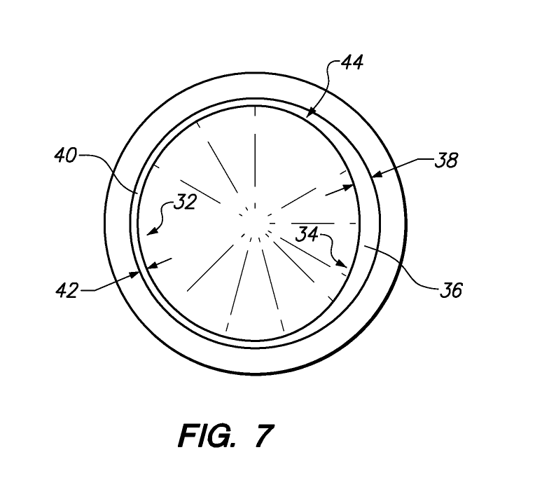

The pressure applicator 20 may comprise an annular ridge 28 and a bulbous protrusion 30. The pressure applicator may be made of any material that is suitable for use in kitchen implements, including but not limited to metal, plastic, wood, ceramic, or combinations thereof. The annular ridge 28 may be sized and positioned to fit on annular rim 24 and within annular flange 26 of the grating and juicing member 12 as shown by the dash lines in FIG. 1. The bulbous protrusion 30 may have a first surface portion 32 and a second surface portion 34, as shown in FIGS. 1 and 7. The first surface portion may be radially symmetrical about a vertical axis 60 (see FIGS. 1 and 7), with a constant radius at any two points intersecting with any one plane transverse to the vertical axis 60. To this end, by way of example and not limitation, the first surface portion 32 may be spherical, hemispherical, ellipsoidal, or prolate spherical or combinations thereof. The second surface portion 34 may have a varying radius. By way of example and not limitation, the radius of the second surface portion 34 may be blended with the radius of the first surface portion 32 and gradually be decreased as shown in FIG. 7. At its minimum radius, the cavity 36 is the largest so that food product to be grated can be held therein when the applicator 20 is seated on the grating and juicing member 12 as shown by the dash lines in FIG. 1.

To use the grating and juicing member, the bulbous protrusion 30 may protrude into the grating and juicing member 12 without contacting one or more of the plurality of cutting edges of the concave grating surface 14 when the annular ridge 28 is seated upon the annular rim 24 and disposed within the annular flange 26. A first distance 38 may thus be formed between the first surface portion 32 and the concave grating surface 14. This first distance 38 may vary just as the radius of the second surface portion 34 of the protrusion 30 varies, as discussed herein. A second distance 42 may thus also be defined between the second surface portion 34 and the concave grating surface 42.

The first distance 38 may be from 1/32 to ⅛ of an inch. However, it is also contemplated that the first distance may be larger or smaller than this stated range. Preferably, the first distance 38 remains constant. The second distance 42 may vary according to the curvature and radius of the second surface portion 34. It is contemplated that the radius of the second surface portion 34, in relation to the vertical axis 60 in a plane transverse to the vertical axis, may be smallest at points on the second surface portion 34 furthest from first surface portion 32, and would increase to approach the radius of first surface portion 32 at points nearer to the first surface portion 32. In such an embodiment, the first and second surface portions 32, 34 may smoothly blend into each other as shown in FIG. 7.

To grate a first food product, the grating and juicing member 12 is oriented in the grating position with the grating and juicing member 12 disposed on (e.g., attached to, threaded to, seated on) the receptacle 22. The first food product is placed on the grating surface 14. The pressure applicator 20 is positioned on the grating and juicing member 12 so that the first food product is positioned adjacent to the second portion surface 34. This also positions the first food product in the second gap 36. The first food product may then be pressed against the plurality of cutting edges of the concave grating surface 14 by rotation of the pressure applicator 20. As the pressure applicator 20 is rotated, the cutting edges formed on the grating surface 14 grates the first food product. The grated food product falls through the plurality of apertures 18 into the receptacle 22.

The receptacle 22 may have sides 48, a base 50, and an annular lip 52. The receptacle 22 may be of any size or dimension suitable for holding a grated first food product and/or a juiced second food product. The receptacle 22 may be made of any material suitable for holding grated or juiced food products. Particularly, the receptacle may be made of metal, plastic, ceramic, wood, or combinations thereof.

In one embodiment, the receptacle 22 may have fastening elements on sides 48 near the annular lip 52. The fastening elements may be configured to engage the grating and juicing member 12 when the grating and juicing member 12 is in the grating position. In addition or alternatively, the grating and juicing member 12 may have fastening elements configured to engage the receptacle 22 when the grating and juicing member 12 is in the grating position. Such fastening elements may include, but are not limited to, screws, threads, connections, clamps, couplings, hooks, joints, latches, dowels, lugs, nuts, seams, or combinations thereof. In a specific embodiment, the receptacle 22 may have exterior-facing annular threads 54 and the grating and juicing member 12 may have an annular wall 56 with interior-facing annular threads 58. The annular threads 54 and 58 may be configured to threadedly engage so as to fasten together the grating and juicing member 12 and the receptacle 22 when the grating and juicing member 12 is used in the grating position.

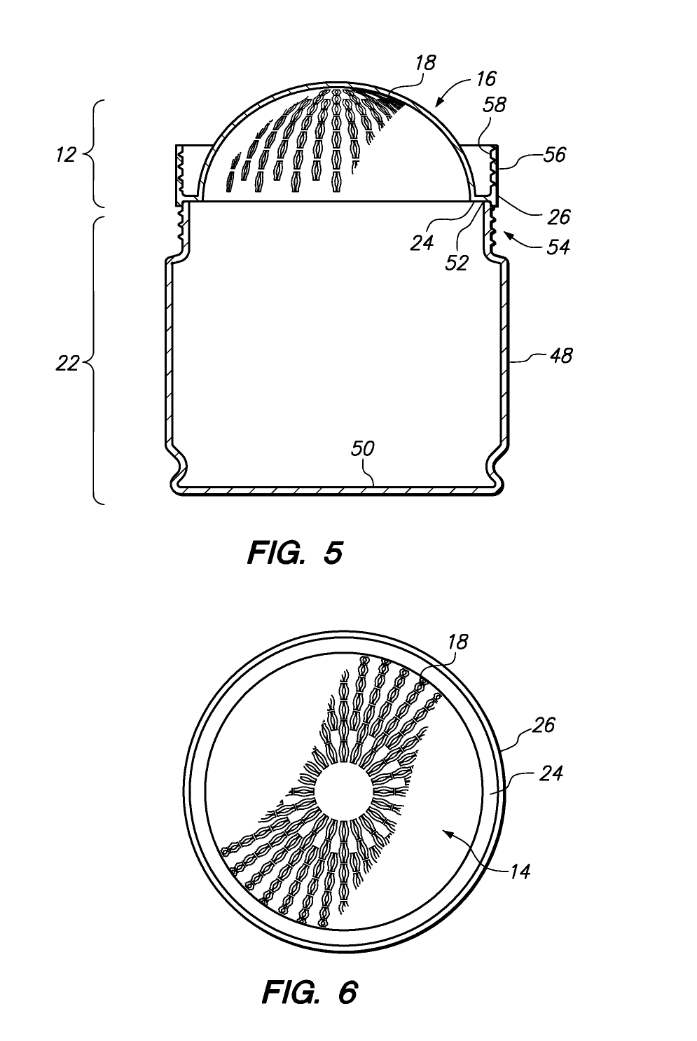

As shown in FIG. 5, the grating and juicing member 12 may be flipped over and placed on top of the receptacle 22 for use in a juicing position. The convex juicing surface 16 of the grating and juicing member 12 may face upwards in a juicing position for juicing a second food product, such as, but not limited to, a citrus fruit. The convex juicing surface 16 may be sized and dimensioned in any size and dimension suitable for juicing a second food product. It is contemplated that the convex juicing surface 16 may have ridges. During juicing, the juiced second food product may pass through one or more of the plurality of apertures 18.

The juiced second food product may pass into a receptacle 22 after passing through one or more of the plurality of apertures 18. The annular rim 24 of the grating and juicing member 12 may be sized and dimensioned to be seated on top of annular lip 52 of the receptacle 22, and annular lip 52 of the receptacle 22 may be horizontally retained by annular flange 26 of the grating and juicing member 12. This holds the grating and juicing member 12 in place when the grating and juicing member 12 is in the juicing position and the user is juicing a second food product.

The grating and juicing apparatus 10 may have an annular wall 56, which may, during juicing, function to prevent a juiced second food product from spilling over the grating and juicing member 12.

The plurality of cutting edges of concave grating surface 14 may be any comminuting structures, such as but not limited to, blades or wedges. Grating may be performed by utilizing the pressure applicator to press a first food product against the grating surface. The grating surface may also be used for zesting. By way of example and not limitation, a user may press the exterior surface of a lemon, lime or other food product without the pressure applicator to remove the top layer of the food product's rind.

Alternative embodiments are contemplated in which variations in the second surface portion 34 of the bulbous protrusion 30 may result in varying surface features, including but not limited to surface features that are stepwise, linear, sinusoidal, exponential, logarithmic, curvilinear, or combinations thereof.

The above description is given by way of example, and not limitation. Given the above disclosure, one skilled in the art could devise variations that are within the scope and spirit of the invention disclosed herein, including various ways of attaching the grating and juicing member 12 to the receptacle 22. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An apparatus for grating a first food product and juicing a second food product, comprising:
a bowl-shaped grating and juicing member defining an opposing concave grating surface and convex juicing surface, the member having a plurality of apertures;
said concave grating surface being radially symmetrical about a vertical axis such that any two points on the concave grating surface intersecting with any one plane transverse to said vertical axis are at a constant radial distance from said vertical axis;
said concave grating surface being configured with a plurality of cutting edges to grate a first food product;
said convex juicing surface being configured with a plurality of ridges to juice a second food product; and
wherein the plurality of apertures are sized and configured to allow a grated first food product to pass through the apertures when the bowl-shaped member is traversed to a grating position, and to allow a juiced second food product to pass through the apertures when the bowl-shaped member is traversed to a juicing position.

2. The apparatus of claim 1, further comprising a pressure applicator for bringing a first food product into contact with the concave grating surface.

3. The apparatus of claim 2, wherein the grating and juicing member further comprises an annular rim and an annular flange, and the pressure applicator comprises an annular ridge and a bulbous protrusion;
said annular ridge being sized and dimensioned to be seated on the annular rim and within the annular flange;
said bulbous protrusion being sized and positioned to project into the grating and juicing member when seated on the annular rim and within the annular flange, but not protruding so far as to contact the concave grating surface;
said bulbous protrusion having a first surface portion and a second surface portion, said first surface portion being symmetrical about a vertical axis such that any two points on said first surface portion intersecting with any one plane transverse to the vertical axis are at a constant radial distance from the vertical axis, and said second surface portion having at least two points intersecting with at least one plane transverse to the vertical axis that are not at a constant radial distance from the vertical axis;
wherein when the annular ridge is seated on the annular rim and within the annular flange, there is a first gap between the first surface portion and the concave grating surface, said first gap having a constant first distance, and a second gap between the second surface portion and the concave grating surface, said second gap having a varying second distance and being sized and dimensioned to contain a first food product; and
wherein the pressure applicator may be rotated to press the first food product against the plurality of cutting edges of the concave grating surface.

4. The apparatus of claim 3, wherein the dimension of the bulbous protrusion is chosen from the group consisting of: spherical, hemispherical, concical, prolate spheroid, ellipsoid or combinations thereof.

5. The combination grater and juicer of claim 3, wherein the constant first distance is between 1/32 and ⅛ of an inch.

6. The apparatus of claim 3, wherein the second surface portion blends to the first surface portion at a surface portion interface.

7. The apparatus of claim 3, wherein the curvature of the second surface portion taken upon a plane transverse to the vertical axis is chosen from the group consisting of: stepwise, linear, sinusoidal, exponential, logarithmic, curvilinear, or combinations thereof.

8. The apparatus of claim 1, further comprising a receptacle for containing a grated first food product and a juiced second food product.

9. The apparatus of claim 8, wherein the grating and juicing member attaches to the receptacle when used in a grating position and attaches to the receptacle when used in a juicing position.

10. The apparatus of claim 1, wherein the grating and juicing member further comprises an annular wall sufficiently high to contain a juiced second food product when the grating and juicing member is used to juice a second food product.

11. A grating apparatus, comprising:
a bowl-shaped grating member having a concave surface configured with a plurality of cutting edges to grate a food product, a plurality of apertures, an annular rim, and an annular flange;
a pressure applicator having an annular ridge and a bulbous protrusion;
said bulbous protrusion having a first surface portion and a second surface portion, said first surface portion being symmetrical about a vertical axis such that any two points on said first surface portion intersecting with any one plane transverse to the vertical axis are at a constant radial distance from the vertical axis, and said second surface portion having at least two points intersecting with at least one plane transverse to the vertical axis that are not at a constant radial distance from the vertical axis;
wherein when the annular ridge is seated on the annular rim and within the annular flange, there is a first gap between the first surface portion and the concave grating surface, said first gap having a constant first distance, and a second gap between the second surface portion and the concave grating surface, said second gap having a varying second distance and being sized and dimensioned to contain a first food product; and
wherein the pressure applicator may be rotated to press the first food product against the plurality of cutting edges of the concave grating surface.

12. A method of using a combination grating and juicing apparatus comprising the steps of:
providing a bowl-shaped grating and juicing member defining an opposing concave grating surface and convex juicing surface, the member having a plurality of apertures;
the curvature of said concave grating surface of said grating and juicing member being radially symmetrical about a vertical axis such that any two points on the concave surface intersecting with any one plane transverse to said vertical axis are at a constant radial distance from said vertical axis;
said concave grating surface being configured with a plurality of cutting edges to grate a first food product;
said convex juicing surface being configured with a plurality of ridges to juice a second food product;
said plurality of apertures being sized and configured to allow a grated first food product to pass through the apertures when the bowl-shaped member is traversed to a grating position, and to allow a juiced second food product to pass through the apertures when the bowl-shaped member is traversed to a juicing position;
flipping the member to access the concave grating surface to grate a first food product; and
flipping the member to access the convex juicing surface to juice a second food product.
